(19) United States
(12) Patent Application Publication
(10) Pub. No.: US 2011/0132525 A1
(43) Pub. Date: Jun. 9, 2011

(54) Mold And A Method Of Manufacturing Large Diameter FRP Flues

(76) Inventor: Qun Xia, Weston, FL (US)

(21) Appl. No.: 12/831,506

(22) Filed: Jul. 7, 2010

(30) Foreign Application Priority Data
Dec. 4, 2009 (CN) 200910249925.9
Dec. 4, 2009 (CN) 200920293550.1

(51) Int. Cl. B29C 70/32; B65H 81/02

(52) U.S. Cl. 156/191; 156/425

(57) ABSTRACT

A mold and method is provided for manufacturing a large diameter fiber-reinforced plastic (FRP) cylinder. Longitudinal ends of a circumferential plate are connected with end plates. Central axes stick out at the center of the end plates. Both sides of the circumferential plate and in the radial directions are connected with inward flange plates. The inner side of the circumferential plate is equipped with a back plate that is connected with the end plates and the inward flange plates. Supporting beams are set between inner sides of the circumferential plate and the back plate. The method for manufacturing large diameter FRP cylinder includes the following procedures: (1) applying releasing wax on the external surfaces of circumferential plate and inward flange plate on the mold; covering polyester films, making the inner liner; continuously rotating the mold, wind reinforcing fibers around the entire mold external surfaces; and resins or composites are showered along the longitude; (2) curing; (3) mold unloading; (4) truing; and (5) finishing. This invention resolves the inconvenience and technical problems of transporting an entire piece of large diameter FRP cylinders, onsite winding and installations.

### CROSS REFERENCES TO RELATED APPLICATIONS

This application is based upon Chinese Patent Application No. 200910249925.9 filed Dec. 4, 2009 and Chinese Patent Application No. 200920293550.1 filed Dec. 4, 2009.

### BACKGROUND OF THE INVENTION

1. Technical Field

This invention relates to the technical field of large diameter fiber-reinforced plastic (FRP) flues for chimneys and, more particularly, to a mold and method for manufacturing large diameter FRP cylinders.

2. Background Technologies

The implementations of environmental conservation policies in the US and western countries, particularly for flue gas desulfurization, initiated the sulfur dioxide removal in the late 1970s and early 1980s by using desulfurization equipment and the techniques. China (CPR) has since 2005 required and encouraged national environmental policies for chimneys in operations and newly constructed ones nationwide to be fit or retrofit for desulfurization so as to reduce the emission of sulfur dioxide.

Most conventional desulfurization techniques are in the method of wet scrubbing, meaning that flue gas comes out of boiler, through the scrubber and a shower of alkaline solutions, then enters breeching and the chimney to be discharged into atmosphere. However, about 5% of the sulfur dioxide still remains in the flue gas being discharged. Since the temperature of the flue gas stays around 120° F., sulfur dioxide mixing with oxygen and water turns into diluted sulfuric acid. Sulfuric acid causes acidic corrosions to the concrete and steel ducts and chimneys. Over a period of time, the corrosion will damage the concrete and steel chimneys partially or in a large scale or even collapse them.

The work conditions of the flue gas in chimneys before desulfurization go as high 266° F. to 302° F. in temperature. While scrubbers are in operation, the temperature of the wet flue gas goes down to about 120° F. When the generation units start up, flue gas will be super heated to as high as about 356° F. in a short period of time.

At the time of massive promotions of the desulfurization, the protections of the chimney structures are facing extraordinary serious challenges; no matter what anti-corrosion materials or techniques used, foreign or domestic, almost 90% or more chimneys will leak within a year. Consequently acids penetrate into the substrates of steel, seriously damage the structure of the chimney and put safety on risks. The potential losses in China along can be dozens of billions RMB (billions of US dollars).

Until today, the anti-corrosion liners inside chimney are categorized as: coating, mortar, borosilicate and foaming block lining, tile, alloy or titanium, and fiber-reinforced plastic (FRP) laminate lining.

Coatings crack easily, delaminate with limited thickness and mortars performs poorly on permeation and often disband and crack. Borosilicate and foam blocks need extended time for constructions. Tens of thousands grouting seams will be generally damaged from several flawed seams, which is co-related and interactive. Tile type of lining is the same as well due to the numerous seams. Titanium alloys are expensive and welding seams are subject to damages. Inevitable leaking also occurs. FRP flues on the other hand are more and more applied due to its temperature resistance, corrosion resistance, and reliable performance.

The main reason of the above mentioned anti-corrosion material failures in the chimney is because the materials are in contact with acid proof brick liner or concrete. Once damaged, acidic solutions penetrate into the brick liner and concrete may lead to structural damages.

In order to avoid chimney structural damages, flues inside the chimney shells or supporting structures are required. Flues are categorized into steel flues, brick/concrete flues, and fiber-reinforced plastic (FRP) flues. While steel and brick flues are easily damaged, FRP flues perform well.

However, at the time of using FRP or composites flues, large diameter FRP flues with diameters bigger than 10 feet or 12 feet, have to be manufactured with vertical filament winding apparatus established near the project site, in order to avoid high costs in trucking the FRP flues from the shop to the chimney or because of difficulty of transportation.

Even if the large diameters flues are cylindrically and vertically wound and manufactured onsite, with the diameter from 10 feet to 12 feet, even 15 feet to 30 feet wide, onsite vertical windings could face difficulties, such as weather, temperature, wind etc. A large hole needs to be cut in the chimney or duct to carry the FRP cylinders for installations. In the meantime, hoisting FRP cylinders around the chimney demands high level hoisting equipment and operations.

The above mentioned problems still restrict the extensive applications of large diameter FRP flues. The major limitations are existing complications in manufacturing large diameter FRP flues, difficulties in transportations, complexity in constructions, elevated costs, and low acceptance by industrial customers.

### BRIEF SUMMARY OF THE INVENTION

The invention aims to provide a mold and a method in manufacturing large diameter fiber-reinforced plastic (FRP) cylinders, to be conveniently fabricated in shops in quantities, making it easier for trucking and installations, and resolve the prior technical problems and difficulties for large diameter FRP flues and cylinders in transportations, onsite winding and installations.

The invention takes the following technical proposals in order to accomplish the above mentioned goals.

One type of mold for large diameter FRP cylinder mold for fabrication, comprises a circumferential segment plate, longitudinally ends with two end flat plates, and center axes which stick out longitudinally from the middle of the end plates. Both sides of the circumferential segments are connected with inward flange flat plates at radial directions. The inward flange flat plates are also connected with the said end plates.

On the inner side of the segment plates is the back side plate which can be connected with inward flange plates and end plates and supporting frames that are installed at the inside of the segment plate and the back side plate.

A method in manufacturing large diameter FRP cylinders includes the following procedures:
1. Apply release wax on the segment plate and the inward flange plate surfaces of the mold; wrap polyester film to create the inner separation layer; the mold starts continuously revolving around the axis, reinforced fiber materials will be wound around and cover the segment plate and inward flange plate and the entire surfaces, wherein fiberglass filament is cross over winding, and fiber glass cloth is more circumferentially wound. After the round of fiber and glass mesh cloth winding is completed around the entire mold, the mold stops revolving. The composite resin can be showered longitudinally. The mold can be revolved at a small angle. Composite resin can be showered longitudinally while the shower head moves in a reciprocating motion. The mold can remain still during showering. After each way of showering, the mold is revolved at a small angle again. During showering, the fender plates sustain pressing onto the inward flange plate to prevent the flow of the resin materials, until the completion of showering the layer on the outer surfaces of the mold segment plate and the inward flange plate. The fender plates can then be removed to allow the mold in continuous revolving state. Additional layers of fiberglass filament or glass mesh cloth can be wound. The above procedure times can be repeated until the composites reach the desired thickness.
2. Curing: revolve the mold slowly, and maintaining the even thickness of the wound FRP cylinder segment on the mold before curing until the FRP segment turn dimensionally stable.
3. Mold unloading: longitudinally unload the entire piece of the wound FRP cylinder segment from the mold by using an unloading machine.
4. Truing: Trim the unloaded cylinder to the desired length and inward flanges to the desired width, and thereafter grind the surface to a specified finish. Cut off the excess wetted fiberglass filament or glass mesh cloth that was on the back side of the mold. A segment section of the cylinder is thus manufactured.
5. Finishing: drill flange holes on both side inward flanges of the cylinder segment, and grind and roughen the outside surface of the inward flanges for better chemical bonding. While in the shop, connect all the cylinder segments into a cylinder by bolting through the inward flange holes, and pre-connect and adjust the cylindrical segment and entire circumference. Eventually by this procedure, FRP cylindrical segments are assembled into a circumferential FRP cylinder.

The beneficial effects of the invention are: manufacturing the large diameter FRP cylinders in shops and in quantity, facilitating transportations and installations, resolving the technical problems and difficulties in transportations of large diameter FRP cylinders, and onsite filament winding, and installations. The invention also greatly reduces the costs of productions, enhances the applications of most effective FRP flue anti-corrosion technology, resolves a large number of industrial chimney problems demanding urgent solutions, and effectively facilitates the development of environmental industries.

A more detailed explanation of the invention is provided in the following detailed descriptions and appended claims taken in conjunction with the accompanying drawings.

### BRIEF DESCRIPTION OF THE DRAWINGS

FIG. 1 shows the mold structure of the invention.

FIG. 2 shows one quarter of circumferential segmental mold of the invention.

FIG. 3 shows the molded fabrication of the segmental section.

FIG. 4 shows the mold fabricated segmental section before mold unloading.

FIG. 5 shows the mold fabricated segmental section after mold unloading.

FIG. 6 shows the assembled cylinder from mold fabricated segmental sections.

FIG. 7 shows the assembled chimney flue from said cylinders.

### DETAILED DESCRIPTION OF THE INVENTION

The following is a detailed description and explanation of the preferred embodiments of the invention and best modes for practicing the invention.

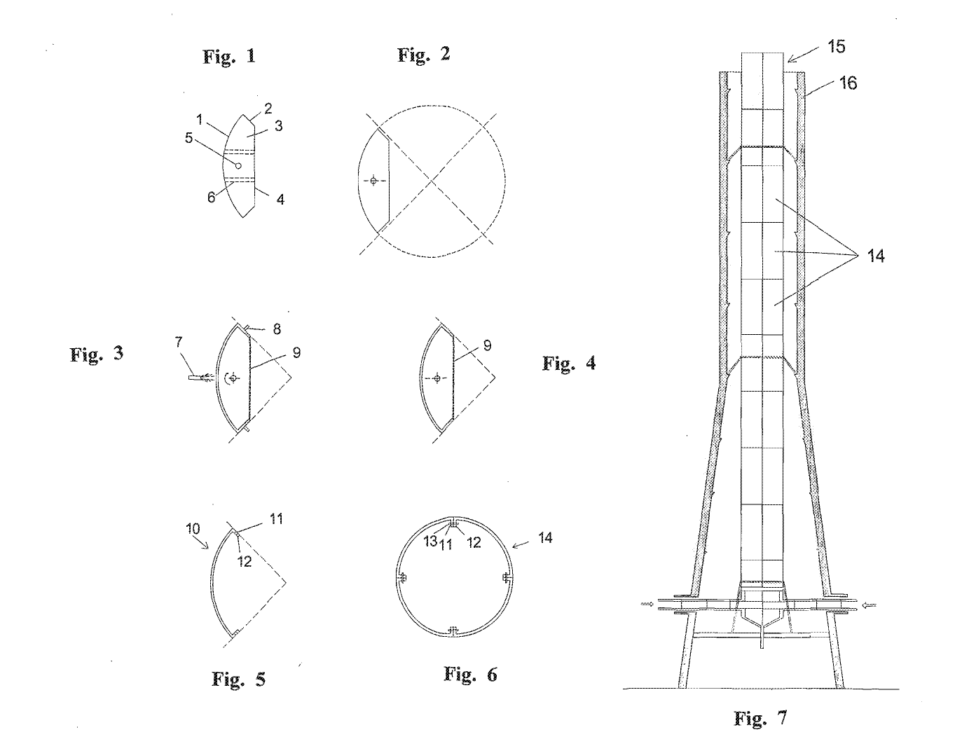

FIG. 1 and FIG. 2 show one kind of mold for large diameter fiber-reinforced plastic (FRP) cylinder fabrications is made of metal by welding. The mold comprises one section of circumferential segment plate 1. End plates 3 are connected to both ends of circumferential segment plate 1. Central axes 5 are connected and protrude outward at the centers of end plates 3. Radial inward flange plates 2 are connected to both sides of the circumferential segment plate 1. Both longitudinal ends of the radial inward flange plates 2 are connected with the end plates.

The inside of said circumferential segment plate 1 is structured with back side plate 4, connected with end plates 3 and inward flange plates 2. Supporting beams 6 brace between the circumferential segment plate and the back side plate.

FIG. 1 and FIG. 2 show the mold for circumferential segments in 4 sections.

This invention completely resolves the problems in extensively manufacturing large diameter FRP cylinders (chimney flues or tanks) in shops, instead of vertically filament winding large diameter FRP cylinders on site.

FIG. 1 and FIG. 2 show the invention with a one-quarter (¼) circumferential section mold. It can be 1 out of segmental sections of 3, 5, 6 or even dozens. The characters of the mold are that its diameter of the circumference is equal to the ¼ of the FRP inner surface diameters. Both side radial surfaces are actually inwardly parallel translated in the distance of the FRP cylinder thickness, in order to ensure the integral circular shape after joining with another ¼ circumferential section. The mold radial surface width can be 30 cm wider than the required FRP inward flanges. The back side of the mold can be flat, having protruding circumferences, or even hollow without any backing materials. The structural supporting frames can be inside the mold. Two axes can be installed at the weight centers of the both ends of the mold for easier revolution and positioning, thereby saving the driving power. The back side of the mold can be a non-wet surface, that composite material that will not reach the fiber glass materials on the back surface.

Among the many outstanding characteristic of this invention in sectional FRP cylinder fabrications is at the time of the fabrications, it fabricates the integral longitudinal inward flanges to the cylinders. At the time of fabrication and at the directional turning areas from the cylinder to the inward radius, one or more layers of fiber mesh cloth could be laid manually in order to reinforce the internal strength of the between inward flanges and the cylindrical bodies.

With reference to the above mentioned mold, the method of fabricating large diameter cylinders includes the following procedures:
1) Apply release wax on the segment plate and the inward flange plate surfaces of the mold. Wrap polyester film, to create the inner separation layer. The mold starts continuously revolving around the axis. Reinforced fiber materials can be wound around and cover the segment plate and inward flange plate and the entire surfaces, wherein fiberglass filament can cross over winding. Fiber glass mesh cloths can be more circumferential wound. After the wound of fiber and glass mesh cloth, winding is completed around the entire mold. The mold can then stop revolving. The composite resin can be showered longitudinally. Revolve the mold at a small angle. Composite resin can be showered longitudinally while the shower head 7 moves in reciprocating motion. The mold remains still during showering. After each way of showering the mold is revolved in a small angle again. During showering, the fender plates 8 sustain pressing onto the inward flange plate, preventing the flow of the resin materials, until the completion of showering the layer on the outer surfaces of the mold segment plate and the inward flange plate. The fender plates can be removed to allow the mold in a continuous revolving state. Additional layers of fiberglass filament or glass mesh cloth can be wound. The above procedures can be repeated from time to time until the composites reach the desired thickness (FIG. 3).
2) Mold unloading: longitudinally unload the entire piece of the wound FRP cylinder segment from the mold by using an unloading machine.
3) Truing: Trim the unloaded cylinder to the desired length and the inward flanges to the desired width. Grind the surface to specified finish. Cut off the net wetted fiberglass filament 9 or glass mesh cloth that was on the back side of the mold. A segment section 10 of the cylinder is thus manufactured (FIG. 4 and FIG. 5).
4) Finishing: drill flange holes 11 (FIG. 5) on both side inward flanges 12 of the cylinder segment and grind and roughen the outside surface of the inward flanges for better chemical bonding. While in the shop, connect all the cylinder segments into a cylinder by bolting through the inward flange holes, and pre-connect and adjust the cylindrical segment and entire circumference. Eventually with this procedure, the FRP cylindrical segments are assembled into a circumferential FRP cylinder (FIG. 6).

This invention allows utilizing existing or similar horizontal continuous winding equipment for FRP pipes, altering the computer controlling program for the continuous cylinder or FRP pipe winding continuous fiberglass filament and mesh cloth. This invention can also alter the nonstop showering process to stop the showering until winding one layer to the needed thickness of fiberglass filament or cloth, then allowing showering equipment to move longitudinally for showering. The mold can be revolved in a small angle manually or by electric. Showering equipment once more moves and showers longitudinally until all the fiber glass filament and cloth get wetted out to the requirements. The molded entire surface is then started with the continuous winding process under the computer control, until the FPR circumferential segment reaches the desired thickness.

By adopting the inward flange design and fabrications, winding glass fiber or fiberglass mesh cloth keeps the same overall take-up tensions even on the inward flange radial surfaces. This can be the key of the inward flange surface design. If outward flanges need to be fabricated, there has been no previous way in keeping the take-up tensions during the continuous glass fiber or fiberglass mesh cloth winding until now. The only conventional methods of making outward flanges are bonding and using fixed molds, like making the rest FRP outward flanges. Manually assembly can form outward flanges in extensive length and can be unacceptably slow, leaving the total quality assurance at risk.

Major characteristics of the invention are different from the adoption of whole circumferential mold in fabrications of FRP vessels and FRP products, particularly the fabrications of large diameter FRP cylinders, which are not suitable for trucking transportation, but only via setting up vertical FRP winding facilities on site.

Many large diameter cylindrical products are only used at the working conditions of lower internal pressures, such as gas only flues, or low pressured solution tanks. This invention can avoid expensive on-site vertical winding technologies.

The entire mold can be about 12.5 meters long and the circumferential cylinder sections can be about 12 meters long after fabrications and truing. The length could be shortened as required, by making relatively shorter FRP sectional cylinders on the existing molds.

The invention resolves the problems of effectively using FRP flues inside existing chimneys. How to hoist large diameter FRP flues into the existing concrete chimney shell is an extraordinary difficult problem. The existing conventional method can open up a large hole on the concrete chimney. The sectional and composite cylinders in the invention can be hoisted in from outside of the chimneys, through a relatively much smaller hole opened up on the existing structures and concrete chimneys. Thereafter, the cylinders can be assembled inside the chimneys, and further assembled into the whole FRP flues.

The invention also resolves the problem of fabrications of large diameter FRP cylinders in shops. There is no need to setup a plant near the FRP flue installation site or vertical winding equipment. It avoids the delay in productions due to the weather and waste of composite materials.

The invention further resolves the problems in long distance transportations of large diameter FRP cylinders avoiding the costly 4 meter in diameter as the upper limit for transporting the FPR cylinders and costly large diameter FRP cylinder transportations in general.

The invention enormously promotes the applications of large diameter FRP cylinders in industries. By using superior composite resin materials with temperature resistance and chemical resistance, it can resolve numerous prior problems and difficulties.

The invention is not limited in circumferential sections, but could be sections and inward flange jointed in the shape of an arc, irregular shape but close to circles, rectangle or other shapes.

Although embodiments of the invention have been shown and described, it is to be understood that various modifications, substitutions, and rearrangements of parts, components, and/or process (method) steps, as well as other uses, shapes, construction, and design of the a mold and method for manufacturing large diameter FRP cylinder can be made by those skilled in the art without departing from the novel spirit and scope of this invention.

What is claimed is:

1. A mold for fabricating large diameter fiber-reinforced plastic (FRP) cylinders, comprising:
a section of a circumferential plate with longitudinal ends and a center;
end plates joined with both longitudinal ends of the circumferential plate;
axes extend outwardly and are connected at the centers of the both end plates;
inward flange plates at the radial directions are joined with both sides of the circumferential plate; and
the longitudinal ends of the inward flange plates are connected with said end plates.

2. A mold for fabricating large diameter FRP cylinders in accordance with claim 1 wherein:
the back plate is connected with said end plates and said inward flange plates at the inner side of said circumferential plate; and
supporting beams are set between the inner side of said circumferential plate and said back plate.

3. A method for manufacturing large diameter FRP cylinder with a mold in accordance with claim 1 comprising the following procedures:
1) applying release wax on the segment plate and the inward flange plate surfaces of the mold; wrapping polyester film to create an inner separation layer; the mold starts continuously revolving around the axis, reinforced fiber materials are wound around and cover the segment plate and inward flange plate and substantially the entire surfaces, wherein fiberglass filament cross over winding; fiber glass mesh cloths are more circumferential winding; after the round of fiber and glass mesh cloth winding is completed around the entire mold, the mold stops revolving; the composite resin is showered longitudinally; revolve the mold in a small angle; composite resin is showered longitudinally while the shower head moves in reciprocating motion; the mold remains substantially still during showering; after each way of showering, the mold is revolved in a small angle again; during showering, fender plates sustain pressure onto the inward flange plate, preventing the flow of the resin materials, until the completion of showering the layer on outer surfaces of the mold segment plate and the inward flange plate; removing the fender plates to allow the mold in continuous revolving state, winding additional layers of fiberglass filament or glass mesh cloth; and repeating the preceding procedures from time to time until the composites reach the desired thickness;
2) curing by revolving the mold slowly, and maintaining even thickness of the wound FRP cylinder segment on the mold before cure, until the FRP segment turning dimensionally stable;
3) mold unloading by longitudinally unloading the entire piece of the wound FRP cylinder segment from the mold by using an unloading machine;
4) truing by trimming the unloaded cylinder to the desired length and inward flanges to the desired width; grinding the surface to specified finish, cutting off the wetted fiberglass filament or glass mesh cloth on a back side of the mold; and manufacturing a segment section of the cylinder; and
5) finishing by drilling flange holes on the both side inward flanges of the cylinder segment; grinding and roughening the outside surface of the inward flanges for better chemical bonding; while in a shop, connecting all the cylinder segments into a cylinder by bolting through the inward flange holes; pre-connecting and adjusting the cylindrical segment and entire circumference; and assembling the FRP cylindrical segments into a circumferential FRP cylinder.
